(19) United States
(12) Patent Application Publication
(10) Pub. No.: US 2020/0179092 A1
(43) Pub. Date: Jun. 11, 2020

(54) PORTABLE DISGUISABLE CONTAINER

(71) Applicant: Penelope Moore Eisenberger, Westport, CT (US)

(72) Inventor: Penelope Moore Eisenberger, Westport, CT (US)

(21) Appl. No.: 16/704,840

(22) Filed: Dec. 5, 2019

Related U.S. Application Data
(60) Provisional application No. 62/776,020, filed on Dec. 6, 2018.

(51) Int. Cl. A61C 19/02; A45C 11/24; A45D 44/20; A61C 7/08

(52) U.S. Cl. CPC A61C 19/02; A61C 7/08; A45D 44/20; A45C 11/24

(57) ABSTRACT

A container capable of housing an orthodontic retainer or the like, or any number of small enough items capable of being housed therein, comprising a top lid portion formed with first engaging surfaces, a bottom base portion formed with second engaging surfaces, said lid and base portions defining an opening of a size and shape to accommodate the passage therethrough of said item, said lid and base portions forming means for closing said opening, and said lid and base portions further defining the appearance of a drinking glass coaster or other recognizable product when said opening is closed, wherein said small items may include one or more of earrings, rings, athletic or other types of mouth guards, Invisalign products, dentures, and retainers.

This application claims the benefit of priority pursuant to 35 U.S.C. 119(e) from a U.S. Provisional Patent Application having Application No. 62/776,020 filed Dec. 6, 2019, the text of which is fully incorporated by reference herein as if repeated below.

### BACKGROUND OF THE INVENTION

The present invention teaches a novel portable disguisable container capable of use as an orthodontic retainer container, unlike any known or disclosed in the prior art, that may, by way of example only, be disguised as and can function as an ordinary-looking drinking glass coaster. While an example presented in this patent application relates to an orthodontic retainer container, the present invention contemplates many other uses that will come within the scope of the invention. For example, it is contemplated that the present invention may be used to contain dentures, Invisalign, mouth guards, earrings, rings, and other items.

### A Hypothetical Story—Version 1:

Imagine a large family dinner where two dozen family members and guests are assembled at the Ginsburg home. Lucy, a 15-year old who last month had her braces removed after four years of successful orthodontic treatment, removes her retainer so that she can partake of the delicious but cheesy lasagna her Aunt Shirley always brings to the occasion. Feeling a bit self-conscious about where to place the retainer, she tries to hide it next to the half-eaten bread on her butter plate. Thinking she's safe, Lucy is horrified to hear her 8-year-old cousin Seth blurt out “what's that weird ugly thing?” Lucy responds, by attempting to educate her relatives. All eyes become focused on the retainer when Uncle Jake, who is not known for tact after drinking wine, yells at the top of his voice: “What's it retaining down there? Is it retaining the cheese?” There's laughter. “Ugh!” declares Aunt Mildred, who the family has always known to be a germaphobe. Lucy leaves the table of amused and repulsed relatives and friends, embarrassed and humiliated.

The foregoing rather silly hypothetical is presented in an attempt to humorously illustrate and dramatize the very real concern that people have about removing and hiding their retainer from others during meals and other gatherings. This concern or problem is solved with the present invention. We'll return to this hypothetical story in a Version 2 below, in an effort to dramatize the benefits of the present invention.

Let us be reminded of those among us (from 1 to 4 million people every year according to the American Dental Association) who endure the many months or years of uncomfortable and painful orthodontic treatment required to treat malocclusion or misalignment of the teeth who are thrilled when the treatment is finished. Not only is there physical discomfort dining the adjustments associated with treatment, but the hardware (braces) associated with treatment is often visible. Patients are happy to be able to finally present themselves in a more aesthetically pleasing way.

However, when the braces are removed, a specially fitted retainer is used to prevent the shifting of teeth or their return to the positions which have been sought to be corrected. This retainer may initially be worn at all times other than at meals, or sports or during teeth cleaning. As the patient's bite stabilizes, the retainer may be worn less frequently.

There is a need for a protective and attractive container that is capable of housing a retainer. The present invention fulfills that need in a clever and novel manner.

The prior art does in fact disclose orthodontic retainer containers, which have been around for some time. None known to the undersigned, however, include or even suggest the unobvious novel features of the present invention. Some prior art containers are transportable, such as is the case of that which is disclosed in expired U.S. Pat. No. 6,305,591 of Janice M. Jones, entitled “Container for an Orthodontic Retainer.” By way of example only, none known to the undersigned solve the problem of avoiding embarrassment during meals and gatherings in the manner solved according to the present invention. None are disguised as other unrelated objects such as a drinking glass coaster to sit atop a table or countertop or any eating surface, like the present invention.

Thus, a need exists for an attractive container capable of housing an orthodontic retainer, which, to the observer, is disguised to look like something completely unrelated to orthodontic devices, such as, for example, a drink coaster. The present invention solves this problem in a novel and quite beautiful manner, by providing and teaching a portable orthodontic retainer container disguised as and capable of functioning as an ordinary-looking drinking glass coaster. The ordinary-looking drink coaster will not draw people's attention.

The present invention was created and designed by ten-year-old Penelope Eisenberger, who comes from a lineage recognized for their significant inventions. The significance of the present invention was recognized by the National Society of Women Engineers when out of 108,000 contestants from seven countries, 4th grade Penelope at Green Farms Elementary School was awarded first place in the “Invent Her Future Award” category at the National Invention Convention, at the Henry Ford Museum in Dearborn, Mich. in May of 2018.

The following is a partial list of objects of the invention and is not to be considered all inclusive. Other objects will become apparent from a reading of this specification.

Accordingly, it is an object of the present invention to provide an orthodontic retainer container that is disguised to look like an ordinary-looking drinking glass coaster.

It is a further object of this invention to provide such a retainer container that is portable.

It is another object of the present invention to provide such a container which includes either a user-friendly lift-off top or the addition of grooves that will function as a twist top for easy access.

Another object is to provide rubber or non-slip nubs on the bottom of the container.

A further object of the invention is to provide a personalized and/or customized pattern on the top of the container.

Yet another object is to provide easily separated top and bottom portions that can easily accommodate cleaning by hand or in a dishwasher.

A further object of the present invention is to provide components which may be biodegradable, and which are capable of being 3D printed.

Another object is to provide in a mobile version a sliding door with a locking means that will prevent the retainer from falling out.

Still a further object of this invention is to provide such a container with a clip that extends through the top and bottom to prevent them from being unintentionally separated.

Yet a further object is to provide an attachment to a carabiner or other type of clip that will enable attachment of the container to a backpack, clothing, belt, neckless, bracelet, or other object.

A further object is to provide the subject retainer container in both coaster and mobile configurations.

A further object is to provide the aforementioned invention with a slit or opening to enable free air circulation so that the user's saliva will not create unpleasant odors.

Yet another object is to provide decals that can be “magnetically” attached to the top of the assembly.

Still another object is to provide rubber or other suitable material relatively small rubber “nubs” integral with the bottom of the assembly to prevent undesirable slipping of the assembly along the surface upon which it will rest.

BRIEF SUMMARY OF THE INVENTION

Provided herein is a container capable of housing an orthodontic retainer or the like, or any number of small enough items capable of being housed therein, comprising a top lid portion formed with first engaging surfaces, a bottom base portion formed with second engaging surfaces, said lid and base portions defining an opening of a size and shape to accommodate the passage therethrough of said item, said lid and base portions forming means for closing said opening, and said lid and base portions further defining the appearance of a drinking glass coaster or other recognizable product when said opening is dosed, wherein said small items may include one or more of earrings, rings, athletic or other types of mouth guards, Invisalign products, dentures, and retainers.

### BRIEF DESCRIPTION OF THE SEVERAL VIEWS OF THE DRAWING

FIG. 1 is a perspective type of view of a first embodiment of the present invention;

FIG. 2 is an exploded type of view of the first embodiment of the present invention;

FIG. 3 a perspective type of view of the bottom of said first embodiment of the present invention;

FIG. 4 is a perspective type of view of a second embodiment of the present invention;

FIG. 5 is an exploded type of view of said second embodiment of the present invention;

FIG. 6 is a partial exploded type of view of said second embodiment of the present invention.

### DETAILED DESCRIPTION OF THE INVENTION

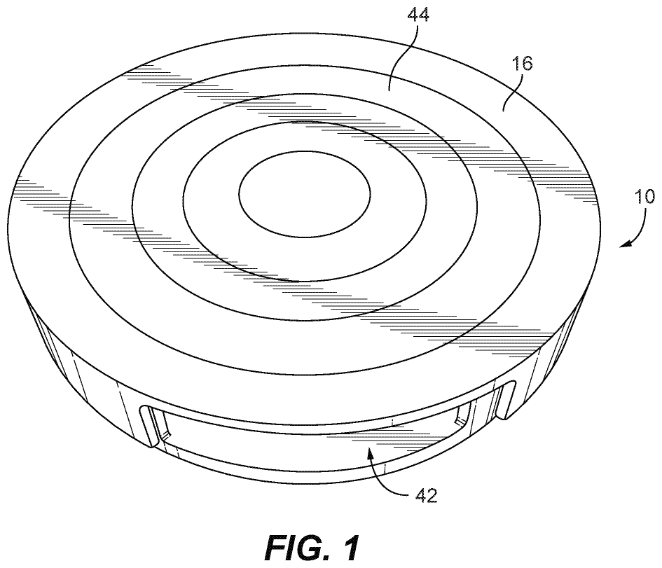

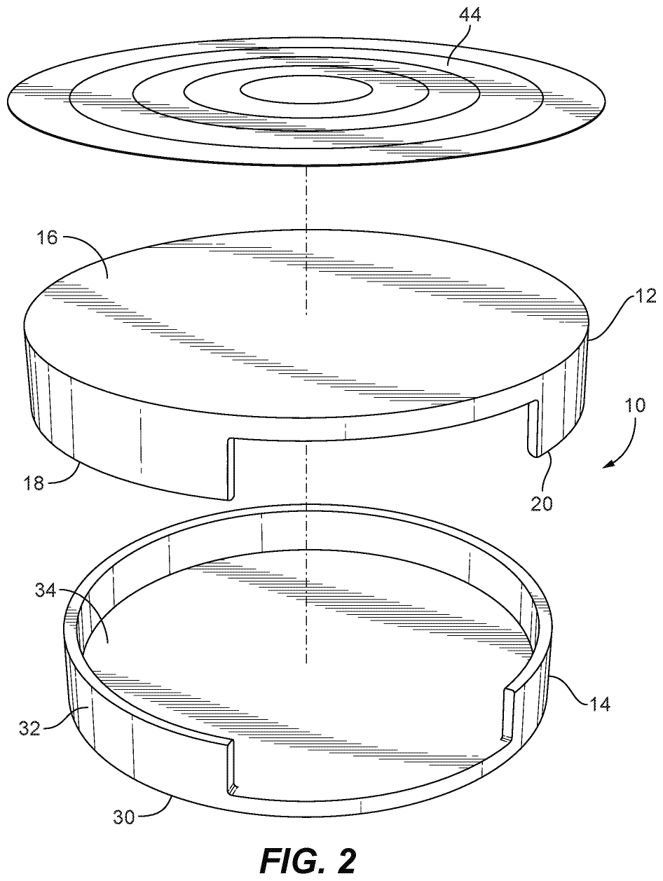

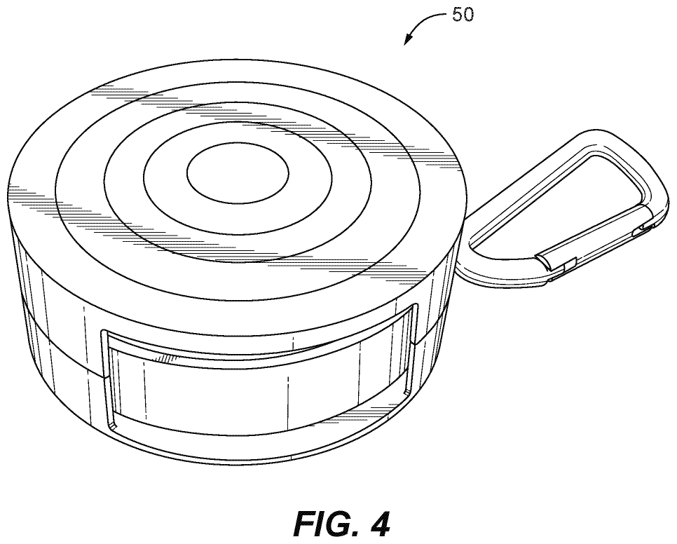

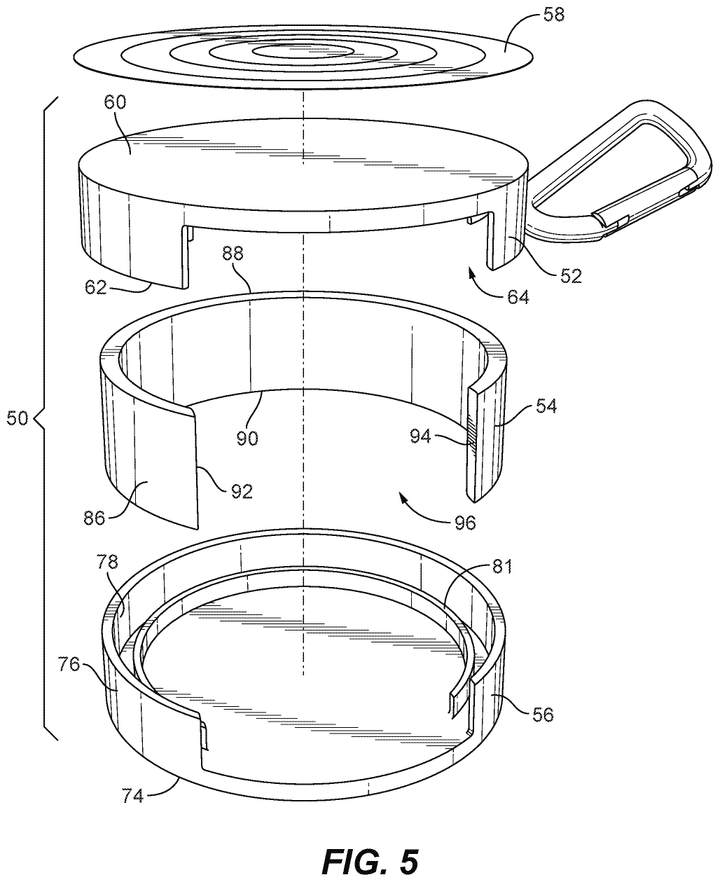

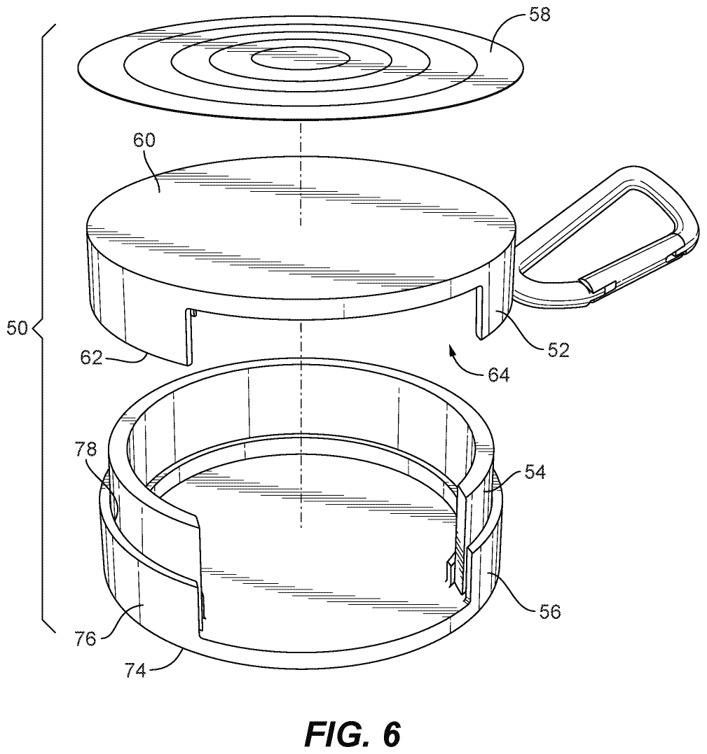

What have been depicted as first and second embodiments of the present invention (FIGS. 1-6) can also be described as coaster (FIGS. 1-3) and mobile or travel (FIGS. 4-6) versions.

Referring now to FIGS. 1-3, coaster assembly 10 is comprised of an upper or top member 12 and lower member 14. Upper and lower members 12 and 14 are formed so as to be able to cooperatively mate with one another. Upper member 12 is formed with a substantially flat top circular top portion 16, which is integral with a substantially cylindrical depending portion 18 of a diameter “X”. Cylindrical portion 18 itself is formed with an opening 20 that extends only partially around a predetermined extent of portion 18. Opening 20 is further defined by edges 24, 26 and 28 that are integral with one another, with edges 26 and 28 being spaced from one another.

Lower member 14 is formed with a substantially flat bottom circular bottom portion 30, which is integral with a substantially cylindrical upstanding portion 32 of a diameter “Y”. Like in top member 12, cylindrical portion 32 is formed with an opening 34 that extends only partially around a predetermined extent of portion 32. Opening 34 is further defined by edges 36, 38 and 40, with edges 38 and 40 being spaced from one another. The distance between edges 38 and 40, on one hand, and 26 and 28, on the other, are preferably the same or substantially similar.

It is to be noted that diameter Y is slightly smaller than diameter X, which facilitates the mating joinder of the top and lower members 12 and 14, such that cylindrical portion 32 is able to rotate within and with respect to cylindrical portion 18, in a nesting configuration. By rotating upper and lower members 12 and 14 when assembled, the user is able to align the openings 20 and 34 to create an access door 42 through which the user is able to place and remove articles such as an orthodontic retainer. Once placed inside by inserting it through door 42, the user thereafter rotates the top and lower members 12 and 14 with respect to one another, thereby “closing” access door 42 and keeping the retainer safe and hidden from view.

What is to be described as an optional circular decal 44 of a diameter substantially corresponding to the diameter of top portion 16 can be either permanently or removably attached to the surface of top portion 16. When assembled and when decal 44 is attached to top portion 16, assembly 10 resembles and becomes disguised as a drinking glass coaster of pleasing appearance. With the retainer hidden inside, assembly 10 provides the retainer-wearing user with a perfect beautiful coaster that will be draw from others praise rather than scorn or disgust. Decal 44, in a removable and replaceable configuration, provides the user with an unlimited ability to enjoy a retainer assembly 10 of many different appearances. For example, a mandala-bearing decal 44 will give the user and those viewing the decal a visual spiritual (Sanskrit) experience. Other opportunities exist for the decal to carry logos of sports teams, products and services, and other trademarks that may have the potential to create licensing revenue.

It is within the scope of the present invention to provide means for removably locking the upper and lower members 12 and 14 together, so that the retainer that has been inserted will not fall out. It is also within the scope of this invention to provide locking tabs (not shown) that will removably lock access door 42 in open and closed positions.

Another feature of the present invention not illustrated in the drawings and not present in the prior art, but within the scope of the invention, is the provision of one or more discreet relatively unseen slits or small openings that will facilitate the free circulation of air. This addresses the problem of the user's saliva accumulating and causing unpleasant odors.

While there is nothing to prevent retainer container 10 from being enjoyed as a mobile container, the present invention provides another embodiment that is specifically designed to be a mobile or portable embodiment. Referring now to FIGS. 4-6, a mobile or portable assembly 50 is shown comprised of three given elements and one optional element. Assembly 50 is comprised of an upper member 52, an intermediary member 54, a lower member 56, and an optional decal 58. Upper, intermediary and lower members 52, 54 and 56 are formed so as to be able to be cooperatively joined in novel mobile assembly 50, as will be explained. Upper member 52 is formed with a substantially flat top circular top portion 60, which is integral with a substantially cylindrical depending portion 62 of a diameter “A”. Cylindrical portion 62 itself is formed with an opening 64 that extends only partially around a predetermined extent of portion 62. Opening 64 is further defined by edges 66, 68 and 70 that are integral with one another, with edges 68 and 70 being spaced from one another.

Upper member 52 is further formed with an arcuate groove that is defined by an arcuate wall 72 that extends from top portion 60 in the same direction as cylindrical portion 62 and is substantially parallel with cylindrical portion 62. Wall 72 begins and ends with edges 68 and 70 so that opening 64 is not interrupted by wall 72.

Lower member 56, in a preferred embodiment of this invention, may be identical to and interchangeable with upper member 52, in order to reduce the cost of manufacturing mobile assembly 50. In any event, lower member 56 is formed with a substantially flat bottom circular bottom portion 74, which is integral with a substantially cylindrical upstanding portion 76 of a diameter “B”. Like in top or upper member 52, a cylindrical portion 76 is formed with an opening 78 that extends only partially around a predetermined extent of portion 76. Opening 78 is further defined by edges 80, 82 and 84, with edges 82 and 84 being spaced from one another. The distance between edges 82 and 84, on one hand, and 68 and 70, on the other, are preferably the same or substantially similar.

It is to be noted that in mobile assembly 50 diameter A and diameter B are substantially identical, although it is within the scope of the present invention that these diameters may vary in magnitude. In the preferred embodiment of this invention, when upper and lower members 52 and 56 are brought together, openings 64 and 78 are able to be aligned to at least partially define a door through which the user is able to insert and remove an orthodontic retainer.

Like upper member 52, lower member 56 is formed with an arcuate groove that is at least partially defined by an upstanding wall 81 that extends from bottom portion 74 in the same direction as cylindrical portion 76, and is substantially parallel with cylindrical portion 76. Wall 81 begins and ends with edges 82 and 84 so that opening 78 is not interrupted by wall 76.

Mobile assembly 50 differs from what is referred to as coaster assembly 10 by its inclusion of intermediary member 54. Intermediary member 54 comprises a substantially cylindrical band wall 86 of a diameter “C”, with an upper edge 88 and a lower edge 90 that are integral with wall 86. Wall 86 is further formed with terminal edges 92 and 94 that are spaced from one another so as to at least partially define a gap 96.

When the elements of mobile assembly 50 are assembled together, upper and lower edges 88 and 90 band wall 86 are able to be inserted into grooves 80 of upper and lower members 22 and 56, since the diameter C of the band wall 86 is substantially the same as the diameters of grooves 80. When assembled, the openings 64 and 78 as well as the gap 96 are able to cooperatively align and define either an open or a closed access door, controlled by the user who is able to rotate the upper, intermediary and lower members 52, 54 and 56 by hand. This door permits the user to place and remove articles such as an orthodontic retainer. Once placed the retainer is inserted through door, the user thereafter rotates the upper and lower members 52 and 56 with respect to one another, thereby “closing” the access door, keeping the retainer safe and hidden from view.

Like decal 44, an optional circular decal 58 can be either permanently or removably attached to the surface of top portion 60. And as has been described for decal 44, when assembled and when decal 58 is attached, mobile assembly 50 resembles and becomes disguised as a drinking glass coaster of pleasing appearance. With the retainer hidden inside, assembly 50 provides the retainer-wearing user with a perfect beautiful coaster that will be draw from others praise rather than scorn or disgust. As has been described for decal 44, there will be opportunities for decal 58 to carry logos of sports teams, products and services, and other trademarks that may have the potential to create licensing revenue.

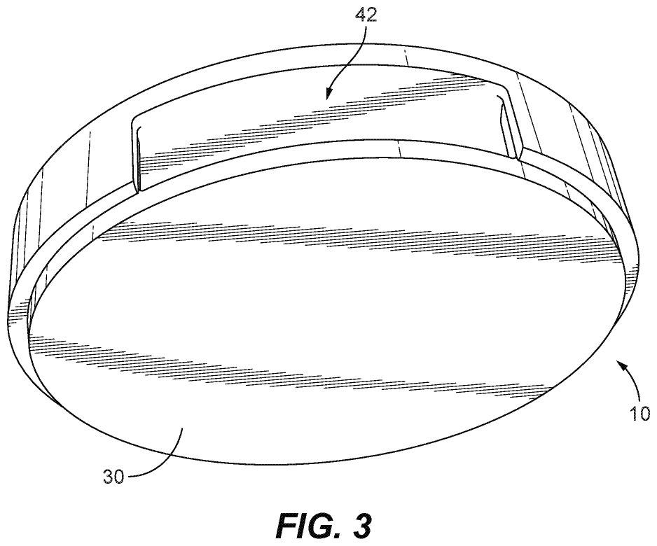

Finally, in FIG. 3 the reader sees four (4) rubber nubs 100 that have been attached to the bottom of coaster assembly 10. These nubs will prevent slipping between the assembly and the surface upon which it is rested. While rubber is the preferred material for nubs 100, the present invention contemplates any suitable material to accomplish this purpose.

### Hypothetical Story—Version 2:

In a Version 2 of our hypothetical illustrative story, we are back at the dinner table in the Ginsburg home. This time there are smiles on the faces of all except Uncle Jake, who has drunk a bit too much wine and is repeating to himself old uninteresting stories. Cousin Seth is busy playing a video game. There is a big pile of lasagna on Lucy's butter plate. She's about to dig in. And next to her butter plate there is a very attractive drinking glass coaster that carries a Mandala design. Lucy's glass of water sits atop this coaster, but its design has drawn the attention of many, including Aunt Mildred, who compliment her on its appearance and ask where they might buy one. Lucy explains that she and a couple of classmates are putting together a company that will own the patent rights not only to this coaster that she has developed, but to a family of portable containers that are capable of being disguised as any number of other objects that will not betray the container's contents. She explains that her invention is capable of being made using their school 3D printer. Lucy smiles to herself, since no one knows that this beautiful coaster contains her orthodontic retainer. The appearance of Lucy's coaster container has successfully disguised its contents, and no one is bothering Uncle Jake who has fallen asleep at the table.

While the present invention has been described using two representative examples of embodiments, other embodiments and examples are able to illustrate the novelty and benefits afforded by this invention, without departing from its proper and lawful scope. And it must be emphasized that the attractive appearance of the coaster and mobile versions of the present invention permit their use as disguised drinking glass coasters with and without anything stored therein.

### LIST OF REFERENCE CHARACTERS

10 coaster assembly
12 upper member
14 lower member
16 circular top portion
18 cylindrical depending portion
20 opening
22 lower member
24 edge
26 edge
28 edge
30 bottom portion
32 upstanding portion
34 opening
36 edge
38 edge
40 edge
42 access door
44 decal
50 portable mobile assembly
52 upper member
54 intermediary member
56 lower member
58 decal
60 circular flat top portion
62 depending portion
64 opening
66 edge
68 edge
70 edge
72 arcuate wall
74 circular bottom portion
76 upstanding portion
78 opening
80 edge
81 wall (defining groove)
82 edge
84 edge
86 cylindrical band
88 upper edge of band
90 lower edge of band
92 terminal edge of band
94 terminal edge of band
96 gap
100 nubs

I claim:

1. A container capable of housing an orthodontic retainer or the like, or any number of small enough items capable of being housed therein, comprising:
a top lid portion formed with first engaging surfaces, a bottom base portion formed with second engaging surfaces,
said lid and base portions defining an opening of a size and shape to accommodate the passage therethrough of said item,
said lid and base portions forming means for closing said opening, and
said lid and base portions further defining the appearance of a drinking glass coaster or other recognizable product when said opening is closed.

2. A container according to claim 1, wherein said small items may include one or more of earrings, rings, athletic or other types of mouth guards, Invisalign products, dentures, and retainers.
